(19) United States
(12) Patent Application Publication
(10) Pub. No.: US 2007/0036087 A1
(43) Pub. Date: Feb. 15, 2007

(54) Method and systems for optimization analysis in networks

(76) Inventor: Per Kangru, Fredriksberg (DK)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/203,502

(22) Filed: Aug. 12, 2005

(51) Int. Cl. H04L 1/00

(52) U.S. Cl. 370/252

(57) ABSTRACT

Methods and systems for providing optimization information for networks.

### BACKGROUND OF THE INVENTION

Present day network operators and equipment manufactures face conflicting demands in terms of quality and investment.

Telecommunications networks provide one illustrative example. In telecommunications networks today two basic paradigms are present, either capacity is over provisioned to ensure quality or quality is guaranteed by means of traffic contracts. Traffic Contracts are the traditional mean of a telecom operator and telecom network equipment manufacturer (NEM). The over provisioning is the approach that IP-carriers in many cases have chosen to adopt.

In Wired networks the amount of capacity is simply the quantity of the optical cables and the capacity of each of them. With the possibility to, today, transmit 40 Gbps in a single fiber, sufficient capacity, in the network core, can be, today, obtained given a proper design. In Wireless networks, capacity is determined by how a finite amount of spectrum is modulated to achieve a high throughput. The capacity and the performance can in many cases be measured in Mbps/km².

In wireless networks, the reduction of user turnover (also referred to as churn) is a key business driver. In a competitive marketplace, network operators strive to improve network coverage and hand off performance in order to reduce dropped call rates, an inverse measure of quality of service which is a key contributor to churn. The network operators face trade-offs between investment, churn and quality of service.

Since capacity in wireless networks is dependent on both the amount of network equipment, i.e. Base Stations, and the optimization of the radio coverage (antenna tuning, frequency planning, power tuning etc.), quality and performance become a factor of investment with a much higher level of investment needed for a certain end user capacity than a Wired core network would have.

A problem arises in balancing a good enough quality against an investment level that the business can support. The concept can be deduced down to two simple parameters: Quality of the connection for the end user and the level of Optimization of the connection for the end user.

Traditionally Quality has been possible to be measured in Voice connections using standardized formulas, PSQM, PESQ, PAMS etc. These are all relevant to Voice calls and voice connections. They are as well based on active traffic generation.

For quality analysis of IP transactions IETF and ETSI have developed a certain amount of test cases. These are based on active testing but can in most cases easily be adopted into a framework of passive testing. Neither IETF nor ETSI have developed any normalization scheme for the test cases, i.e. it is not understood if a certain measurement result is good or bad.

Therefore, there is a need to provide methods and systems that enable network operators and NEMs to understand the level of optimization in both current networks and networks under deployment.

There is also a need to provide means of understanding what is the actual amount of capacity that is present in the systems that the network operators have purchased from the NEM.

### BRIEF SUMMARY OF THE INVENTION

In one embodiment, the method of this invention includes the steps of receiving information from a network for a communication event, determining a quality of service score for the communication event, and determining a network resource utilization score for the communication event. The network can be optimized using the quality of service score and the network resource utilization score.

Systems that implement the method of this invention are also within the scope of this invention.

### BRIEF DESCRIPTION OF THE SEVERAL VIEWS OF THE DRAWING

For a better understanding of the present invention, together with other and further needs thereof, reference is made to the accompanying drawings and detailed description and its scope will be pointed out in the appended claims.

FIG. 1 is a schematic flowchart representation of an embodiment of the method of this invention;

FIG. 2 is a schematic flowchart representation of another embodiment of the method of this invention;

FIG. 3 is schematic representation of a conventional RTP datagram;

FIG. 4 is schematic representation of a conventional UDP datagram;

FIG. 5 is schematic representation of a conventional RTCP datagram;

FIG. 6 is schematic representation of conventional modifications to the RTCP datagram;

FIG. 7 is schematic representation of a conventional protocol reference model used for ATM; and

FIG. 8 is a schematic block diagram representation of an embodiment of the system of this invention.

### DETAILED DESCRIPTION OF THE INVENTION

Methods and systems for providing optimization information for networks are disclosed herein below.

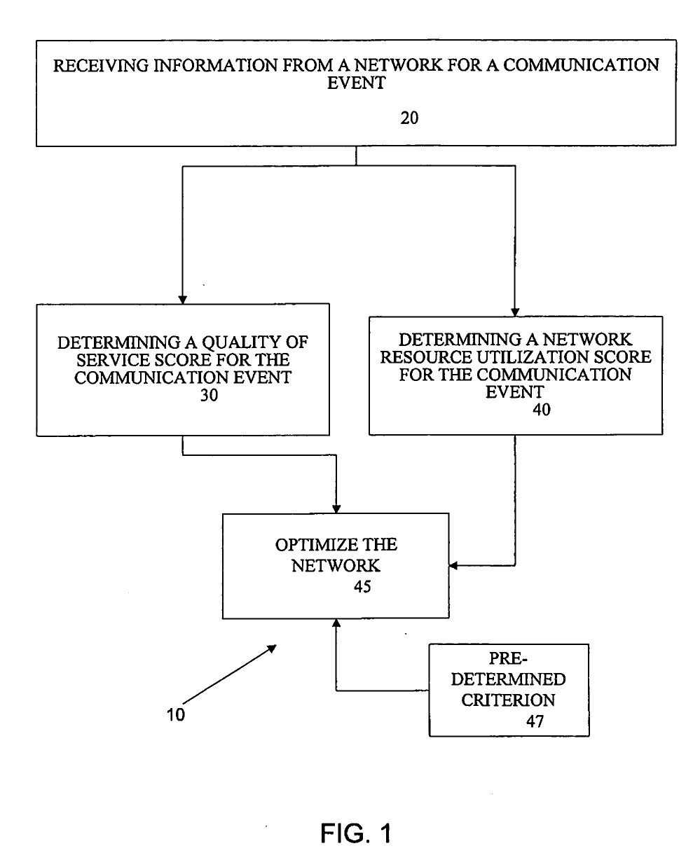

A flowchart of an embodiment of the method of this invention is shown in FIG. 1. Referring to FIG. 1, the embodiment 10 of the method of this invention includes the steps of receiving information from a network for a communication event (step 20, FIG. 1), determining a quality of service score for the communication event (step 30, FIG. 1), and determining a network resource utilization score for the communication event (step 40, FIG. 1). The network can be optimized using the quality of service score and the network resource utilization score.

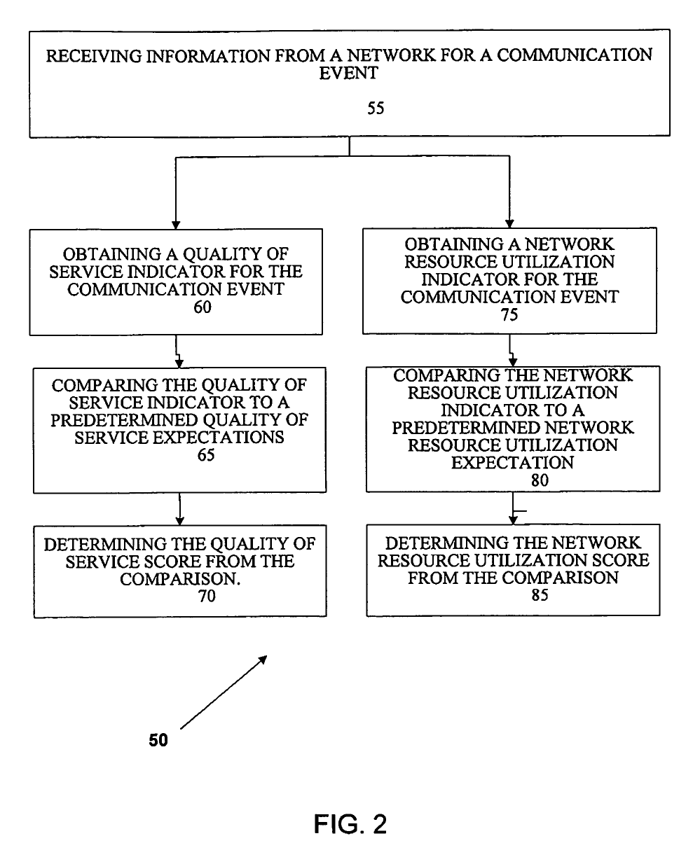

Shown in FIG. 2 is a flowchart of another embodiment of the method of this invention. Referring to FIG. 2, the embodiment 50 of the method of this invention includes the steps of receiving information from a network for a communication event (step 55, FIG. 2), obtaining a quality of service indicator for the communication event (step 60, FIG. 2), comparing the quality of service indicator to a predetermined quality of service expectation (step 65, FIG. 2), determining the quality of service score from the comparison (step 70, FIG. 2), obtaining a network resource utilization indicator for the communication event (step 75, FIG. 2), comparing the network resource utilization indicator to a predetermined network resource utilization expectation (step 80, FIG. 2), and determining the network resource utilization score from the comparison (step 85, FIG. 2).

Some exemplary embodiments of the method and system of this invention are presented here in below. In one instance, for each connection (including, but not limited to, Voice, Video, text and data connections) in a Wireless Network (including but not limited to UMTS, CDMA2k, GSM/GPRS, WiFi, WiMAX, Bluetooth), control plane signaling messages, i.e. messages are used to handle the setup and management of the connection is used. When the connection is established, control plane messages can be used to manage the quality of the connection and to handle handovers, i.e. re-allocation of network resources to connect the connection to a different set of network resources (including, but not limited, to Base Stations, Core networks etc).

In one instance, in the connection, the End User Data (including but not limited to Voice, Video, Text, Data) can be sent. The End User Data is normally sent between either a single to a single recipient (1:1) or between a single sender to multiple receivers (1:Many) or between Many senders to multiple receivers (Many: Many). All of these type of transactions will have some expectation of the Quality of the connection. If the expectation is known, the expectation can be communicated in the network using Control Plane signaling or the User Plane connection.

Using either the communicated Expected Quality information or an expectation of the quality either deduced from the type of communication that is ongoing on the user plane connection or pre-determined levels of expectations, a connection can be benchmarked against an expectation and a quality of service score can be given for the specific connection.

From either the Control Plane Signaling information or from predetermined resource allocation for the connection, the resource allocation, the amount of network resources that are reserved for the specific connection, can be determined. In order to calculate a resource utilization score for each connection, the resource allocation is compared to the actual usage of the connection, determined from the control plane signaling or from the user plane data. In the cases where the network is providing so called ‘soft handovers’, i.e. for a period of time allowing the End User to have multiple connections to the network, all of these connections need to be considered to be part of the resources used.

It should be noted that the quality of service score and the resource utilization score can be utilized, together with a predetermined optimization criterion (47, FIG. 1), to optimize the network (step 45, FIG. 1). The network operator can select the level of quality (related to customer satisfaction) and the resource utilization (related to the investment level) that the network operator wants to develop the network against. This selection of the level of quality and the resource utilization constitutes the optimization criterion.

The details of Quality score calculation algorithm may be different for each of the different services (including, but not limited to, Voice, Data, Video, Text). Various methods of calculating a quality of service indicator have been developed (for a discussion of some of these methods for voice quality indications see, for example, Tech Note: Voice Quality Measurement, by Alan Clark available at http://www.tmcnet.com/tmcnet/articles/2005/voice-quality-measurement-voip-alan-clark-telchemy.htm, which is herein incorporated by reference.). Some, but not only limited to these, of the quality of service indicators for voice systems are the MOS (mean opinion score), the ITU developed PESQ score, and the R factor obtained using the ITU developed “E” model. (The “E” model is also applicable to data other than voice.) The R factor (transmission rating factor) can be derived from the MOS (mean opinion score) as described in ITU temporary document XX-E WP2/12, study group 12, May 2002, which is herein incorporated by reference. The quality of service indicators for voice and for data communications networks can be related as described in ETSI TS 329-5 V1.1.1 (2000-11), “TIPHON (Telecommunications and Internet Protocol Harmonization Over Networks) Release 3; Technology Compliance Specification; Part five: Quality of Service (QoS) measurement methodologies”, which is herein incorporated by reference.

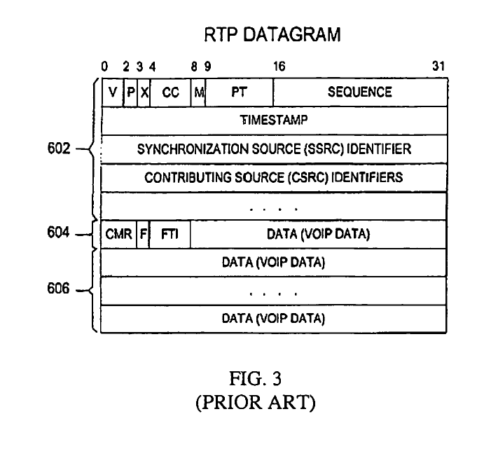

The following example, relating to a voice over IP application, is presented in order to illustrate some of the details of invention presented above. However, it should be noted that this invention is not limited to this example. A VOIP call is routed between a source and a receiver over a network, using Internet Protocol, and through a number of gatekeeper servers. A signaling protocol (such as SIP or H.323) establishes a transmit and receive channel over the IP network. The VOIP data communication utilizes the Real-Time Transport Protocol/User Datagram Protocol/Internet Protocol (RTP/UDP/IP) as the protocol stack. An example of an RTP datagram is shown in FIG. 3. The RTP fields include fields for a sequence number, time stamp, synchronization source identifiers, and contributing source identifiers. (RTP is defined in RFC 3550, “RTP: A Transport Protocol for Real-time applications”, July 2003, available at http://www.ietf.org/rfc/rfc3550.txt, which is herein incorporated by reference.)

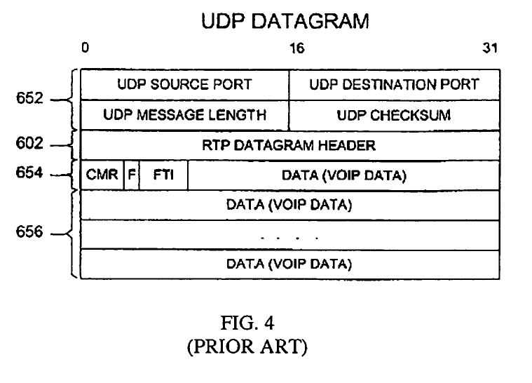

For the source and the receiver, an RTP session is defined by a particular pair of destination transport addresses (one network address plus a port pair for RTP and RTCP). A UDP datagram is shown in FIG. 4 illustrating the port information. Referring to FIG. 3, the timestamp indicates the sampling instant of the first octet in the RTP data packet. The sequence number increments by one for each RTP data packet sent, and can be used to detect packet loss. The SSRC field uniquely identifies the source.

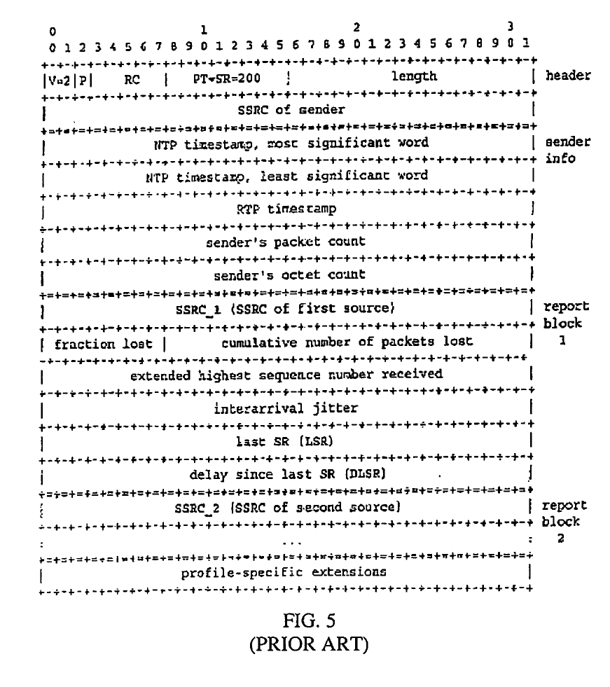

The RTP data transport protocol is augmented by a control protocol (RTCP) to allow monitoring of data delivery (allowing scalability to multicast communication), and to provide some control and identification functionality. Under RTCP, sources and receivers periodically send RTCP packets to each other (using different ports). Each RTCP packet comprises either a sender report or a receiver report followed by a source description (SDES). Sender reports (SR) are generated by the RTP sources. Receiver report (RR) are generated by the RTP receivers. Source description packets, used for session control, include a globally unique identifier, CNAME, and also identify the sender by name, e-mail and phone number. Both sender reports and receiver reports include lost packet and jitter information. The jitter information is obtained from the timestamp. A sender report RTCP datagram is shown in FIG. 5.

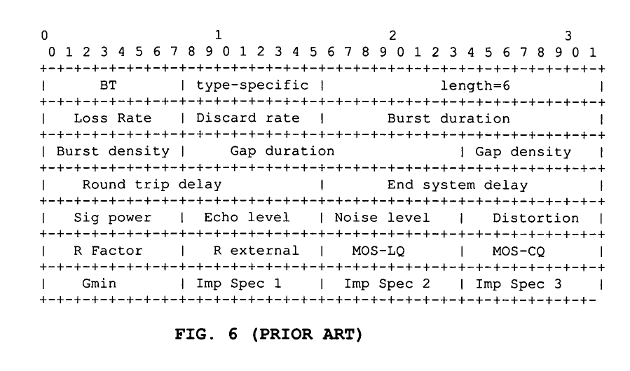

Extensions to RTCP have been proposed that provide concise but useful metrics which relate to quality of service (Internet Draft, RTCP Extensions for Voice over IP Metric Reporting, July 2002, available at http://www.rnp.br/ietf/internet-drafts/draft-clark-avt-rtcpvoip-01.txt, which is herein incorporated by reference.) The format for the RTCP extensions describing the above referenced Internet Draft is shown in FIG. 6. The type specific data (labeled as Imp Spec in FIG. 6) can contain the expected quality information.

The R factor, the ITU defined transmission rating factor which is referred to in FIG. 6, is given by
R=Ro−Is−Id−Ie+A
where:
“Ro” is a base factor determined from noise levels, loudness, etc.;
“Is” is the signal impairment occurring simultaneously with speech, including: loudness, quantization (CODEC) distortion and non-optimum sidetone level;
“Id” is the impairment that is delayed with respect to speech (may include echo and conversational difficulty due to delay);
“Ie” is the ‘equipment impairment factor’ and represents the effects of the communication systems on transmission signals;
“A” is the ‘advantage factor’ and represents the user's expectation of quality when making a using the equipment.

The equipment impairment factor, “Ie”, reflects most of the impact of the communication system on quality of service. “Ie” can be defined, in one embodiment, in terms of the equipment impairment factor due to the packet loss, the equipment impairment factor due to packet delay variation and the equipment impairment factor due to the CODEC. (In one embodiment, the equipment impairment factor can be determined using the methods described in ETSI TS 329-5 V1.1.1 (2000-11), section E.) The resulting equipment impairment factor is the sum of the various contributions. It should be noted that other factors in addition to the above described can contribute and the contributions will be, in one embodiment, added. Since packet delay and packet loss can be determined from the information given by the protocol, the impairment factor can be determined and the R factor can also be determined.

The R factor and the MOS values provide quality of service indicators for the voice over IP event (the communication event). The expected quality information can be compared to the quality of service indicators in order to obtain a quality of service score.

The format as described above includes enough information to identify the sending and receiving ports and to calculate the link utilization as defined in “Bandwidth Measurements In Wired And Wireless Networks”, Licentiate thesis presented by Andreas Johnsson, Malarden University, Vasteras, Sweden, April 2005 (defined as the number of bits transferred during a given time divided by the link capacity, where the link capacity is the bit rate of the link), incorporated by reference herein. A network utilization indicator can be obtained and compared to a predetermined desired network utilization.

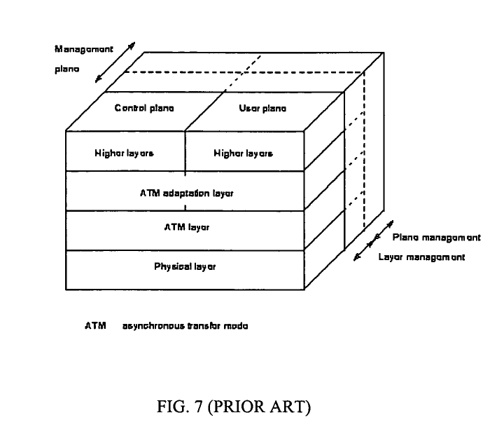

Another example, relating to ATM transmission, is presented below in other to illustrate the method of this invention. (ATM is of interest since ATM is defined for the core transmission of the Universal Mode Telecommunications System, UMTS.) It should be noted that this invention is not limited to this example. The protocol reference model used for ATM is shown in FIG. 7. Referring to FIG. 7, the model can be viewed in terms of three planes, the user plane, the control plane and the management plane, and in terms of at least three layers, the ATM adaptation layer, the ATM layer and the physical layer. In the ATM layer, header information is added to every cell at the transmitter and is removed from every cell at the receiver. The header information includes a Virtual Path Identifier (VPI) and a Virtual circuit Identifier (VCI). As enumerated in RFC 1946, Native ATM Support for ST2+, available at http://www.fags.org/rfcs/rfc1946.html, which is incorporated by reference herein, quality of service parameters for an ATM network include the number of PDU bytes or desired message size, the PDU rate, the delay and the delay variance (jitter). The loss, delay and jitter and the bandwidth utilization can be determined for each flow, where a flow is determined by the source and destination addresses and ports. From the knowledge of the loss, delay and jitter, an indicator of the quality of service can be obtained. As described in RFC 1946, the desired quality of service can also be included in the data for the protocol.

In one instance, a network utilization indicator is defined as the fraction of time per time unit needed to transmit to flow (see Garg, Kappes, “A New Admission Control Metric For Voip Traffic In 802.11 Networks,” Wireless Communications And Networking Conference WCNC 2003, IEEE, which is incorporated by reference herein). Such an indicator could also be used in ATM networks and the protocol provides in of data to calculate the indicator. The network utilization indicator is then compared to a desired network utilization to obtain a network utilization score.

Yet another example is presented hereinbelow in order to illustrate some of the details of invention presented above. In ad hoc networks, such as, but not limited to, wireless networks capable of “soft handovers,” the calculation of network utilization has to take into account the fact that there are multiple routes (links or flows). In one instance, the capacity is defined as the smallest bit rate amongst bit rates for each of the multiple links. The utilization of the link is then defined as the number of bits transferred during one communication session (or during a predetermined time) divided by the capacity. The link utilization can then be compared to the desired or predetermined link utilization in order to determine the link utilization score.

It should be noted that other indicators of utilization are possible, such as, but not limited to, an indication of the number of links or a definition of the equivalent bandwidth for the multiple links. In one instance, the bandwidth for one link is defined as the product of the link capacity and a factor equal to one minus the utilization. For multiple links, the equivalent bandwidth is defined as the smallest bandwidth among the bandwidths for each of the multiple links. In the presence of packet loss, the equivalent bandwidth is a further reduced by a factor equal to one minus the total loss rate.

In order to further illustrate the method of this invention, reference is made to the following exemplary application. The method of this invention can provide a wireless service provider which means by which the wireless service provider can benchmark the entire network and the business model against each other. In one exemplary application, in a UMTS network, the network is developed in many phases. In the first phase the key deliverable is to achieve connection quality for a single or a low number of calls. This is normally not a difficult task and is normally performed by the NEM that is delivering the network equipment. One problem for the Wireless Service Provider is that although a good quality connection can be setup and sustained for a single or a low number of calls the network is not ready for production usage by a high number of subscribers. Utilizing the methods of this invention, the Wireless Service Provide can not only determine the connection Quality but can as well optimize the usage of network resources. Considering the quality of service together with the network utilization enables the Wireless Service Provider to deploy the network into commercial operation at an earlier date and allows the Wireless Service Provider to understand the expected amount of capacity in the Wireless network.

It should be noted that other applications are also within the scope of this invention. It should be also noted that use of this invention can, in some embodiments, depend on the complexity of the system or application. (More complex applications, such as UMTS, may derive more benefit from optimization.)

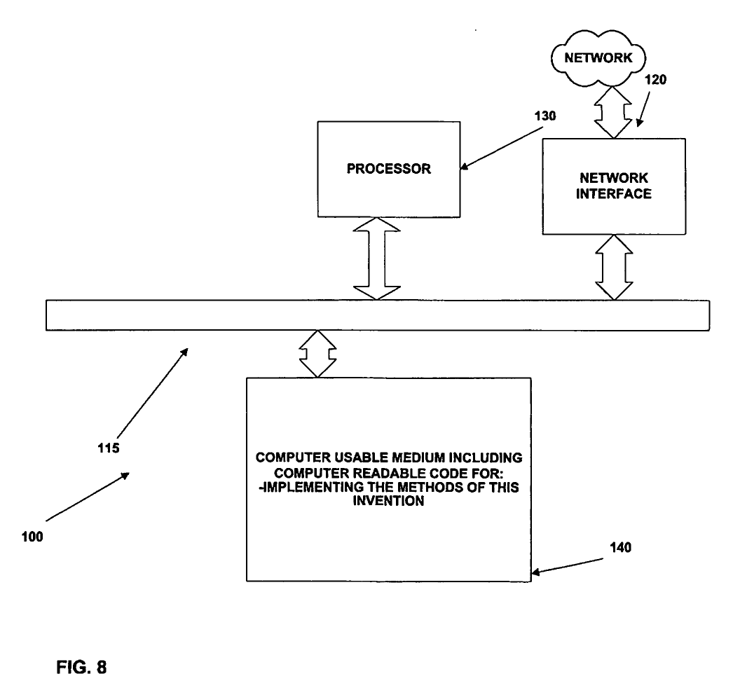

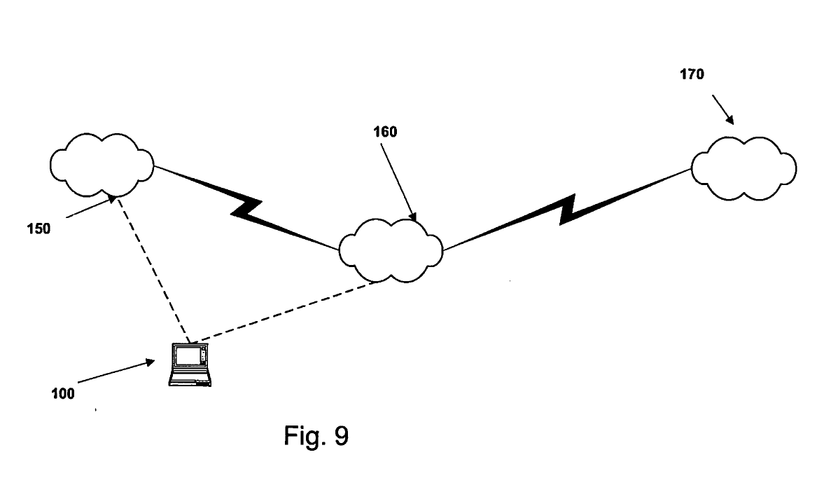

An embodiment of the system of this invention is shown in FIG. 8. Referring to FIG. 8, the embodiment 100 of the system of this invention includes a network interface 120 capable of providing data corresponding to a communication event, one or more processors 130, and one or more computer usable media 140 having computer readable code embodied therein. The computer readable code embodied in the one or more computer usable media 140 is capable of causing the one or more processors 130 to execute the method of this invention, including receiving data from a network corresponding to the communication event, determining from the data a quality of service score, and determining, from the received data, a network resource utilization score. The computer readable code is capable of, but is not limited to, causing the one or more processors 130 to execute the steps in the methods shown in FIG. 2.

In one embodiment, the network interface 120 extracts the data from packets communicating information between the source and the receiver. The network interface 120 extracts the data from the packets using conventional methods. Once the network interface 120 receives each packet, each packet is parsed and the required data are extracted therefrom.

In one embodiment, the network interface 120 includes an acquisition component and a filtering component. The acquisition component can be similar, but is not limited to, to that found in signaling analyzers such as the “J7326A Signaling Analyzer” of AGILENT TECHNOLOGIES, Inc. The acquisition component and Filtering component receive the data from one or more transmission messages and renders the data in a form that can be provided to the one or more processors 130. The acquisition layer and Filtering layer constitute means for providing the data from one or more transmission messages to the one or more processors 130. (In one embodiment, the acquisition component and Filtering component comprise software that instructs the one or more processors 130 to parse the received messages and provides the data to one or more processors 130 for analysis. The same function can be implemented, in another embodiment, in dedicated hardware or dedicated hardware/software.)

The network interface 120, the one or more processors 130, and the computer usable medium 140 are operatively connected by means of a connection component 115 (the connection component may be, for example, a computer bus, or a carrier wave).

An application of the embodiment 100 of the system of this invention is shown in FIG. 9. Referring to FIG. 9, subnetworks 150, 160, and 170 comprise a communication network exchanging or transmitting information in a communication event. The embodiment 100 of the system of this invention is connected such as to be able to capture (observe) the communication event. For example, but it should be noted that this invention is not limited only to this example, the network can be a UMTS network and subnetwork 150 is the radio access network, subnetwork 160 is the ATM network and subnetwork 170 is the core network. The system 100 can be connected in subnetwork 150 or subnetwork 160. In another example, the network is a CDMA2000 network and the subnetwork 160 is mobile switching center (MSC). The system 100 can be, in that example, connected in the subnetwork 160.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices.

Elements and components described herein may be further divided into additional components or joined together to form fewer components for performing the same functions.

Each computer program (code) within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable or usable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized this invention is also capable of a wide variety of further and other embodiments within the spirit and scope of the appended claims.

What is claimed is:

1. A system for providing optimization information in networks, the system comprising:
a network interface capable of providing data corresponding to a communication event;
at least one processor;
at least one computer usable medium having computer readable code embodied therein, the computer readable code be capable of causing said at least one processor to:
receive data, from a network, corresponding to a communication event,
determine, from the received data, a quality of service score for the communication event, and
determine, from the received data, a network resource utilization score for the communication event;
whereby a network can be optimized using the quality of service score and the network resource utilization score.

2. The system of claim 1 wherein the computer readable code, in causing said at least one processor to determine the quality of service score, further causes the at least one processor to:
obtain a quality of service indicator for the communication event;
compare the quality of service indicator to a predetermined quality of service expectations; and
determine the quality of service score from the comparison.

3. The system of claim 2 wherein the computer readable code, in causing said at least one processor to determine the quality of service indicator, further causes the at least one processor to determine a quality of service indicator for a voice system.

4. The system of claim 2 wherein the computer readable code, in causing said at least one processor to determine the quality of service indicator, further causes the at least one processor to determine an equipment impairment factor.

5. The system of claim 1 wherein the computer readable code, in causing said at least one processor to determine the network utilization score, further causes said at least one processor to:
obtain a network resource utilization indicator for the communication event;
compare the network resource utilization indicator to a predetermined network resource utilization expectation; and
determine the network resource utilization score from the comparison.

6. The system of claim 5 wherein the computer readable code, in causing said at least one processor to determine the network resource utilization indicator, further causes said at least one processor to determine a ratio of bits transferred during a given time to a bit rate.

7. The system of claim 1 wherein the computer readable code is capable of further causing said at least one processor to optimize a network performance according to a predetermined optimization criterion.

8. The system of claim 1 wherein said network interface comprises a computer readable medium having computer readable code embodied therein, said computer readable code be capable of causing said at least one processor to:
parse received messages corresponding to the communication event, and
extract said data corresponding to the communication event.

9. A method for providing optimization information in networks, the method comprising the steps of:
receiving information from a network for a communication event;
determining a quality of service score for the communication event;
determining a network resource utilization score for the communication event; and
whereby a network can be optimized using the quality of service score and the network resource utilization score.

10. The method of claim 9 wherein the step of determining the quality of service score comprises the steps of:
obtaining a quality of service indicator for the communication event;
comparing the quality of service indicator to a predetermined quality of service expectations; and
determining the quality of service score from the comparison.

11. The method of claim 10 wherein the step of determining the quality of service indicator comprises the step of determining a quality of service indicator for a voice system.

12. The method of claim 10 wherein the step of determining the quality of service indicator comprises the step of determining an equipment impairment factor.

13. The method of claim 9 wherein the step of determining the network resource utilization score comprises the steps of:
obtaining a network resource utilization indicator for the communication event;
comparing the network resource utilization indicator to a predetermined network resource utilization expectation; and
determining the network resource utilization score from the comparison.

14. The method of claim 9 further comprising the step of optimizing a network performance according to a predetermined optimization criterion.

15. A computer program product comprising:
a computer usable medium having computer readable code embodied there in, said computer readable code being capable of causing at least one processor to:
receive data, from a network, corresponding to a communication event,
determine, from the received data, a quality of service score for the communication event, and
determine, from the received data, a network resource utilization score for the communication event.

16. The computer program product of claim 15 wherein said computer readable code, in causing said at least one processor to determine the quality of service score, further causes the at least one processor to:
obtain a quality of service indicator for the communication event;
compare the quality of service indicator to a predetermined quality of service expectations; and
determine the quality of service score from the comparison.

17. The computer program product of claim 16 wherein the computer readable code, in causing said at least one processor to obtain the quality of service indicator, further causes said at least one processor to determine a quality of service indicator for a voice system.

18. The computer program product of claim 16 wherein the computer readable code, in causing said at least one processor to obtain the quality of service indicator, further causes said at least one processor to determine an equipment impairment factor.

19. The computer program product of claim 15 wherein said computer readable code, in causing said at least one processor to determine the network resource utilization score, further causes the at least one processor to:
obtain a network resource utilization indicator for the communication event;
compare the network resource utilization indicator to a predetermined network resource utilization expectation; and
determine the network resource utilization score from the comparison.

20. The computer program product of claim 15 wherein said computer readable code is also capable of causing said at least one processor to optimize a network performance according to a predetermined optimization criterion.
